(19) United States
(12) Patent Application Publication
(10) Pub. No.: US 2017/0072939 A1
(43) Pub. Date: Mar. 16, 2017

(54) HYBRID VEHICLE

(71) Applicant: Toyota Jidosha Kabushiki Kaisha, Toyota-shi Aichi-ken (JP)

(72) Inventor: Naoki Ishikawa, Toyota-shi Aichi-ken (JP)

(21) Appl. No.: 15/252,593

(22) Filed: Aug. 31, 2016

(30) Foreign Application Priority Data
Sep. 10, 2015 (JP) 2015-178345

(51) Int. Cl. B60W 20/13; B60W 10/08; B60W 10/06; B60W 10/196; B60W 10/10

(52) U.S. Cl. CPC B60W 20/13; B60W 10/196; B60W 10/10; B60W 10/06; B60W 10/08; B60W 2710/0677; B60W 2710/086; B60W 2710/1005; Y10S 903/93; B60Y 2200/92; B60Y 2300/188

(57) ABSTRACT

A controller executes a controlling process including: calculating first power Pa(1) to first power Pa(4) when an engine is requested to be stopped; when a sum of first power Pa and second power Pb at a current transmission gear position is greater than a discharge power limit value Wout of a power storage device, and when there is a transmission gear position at which the sum of first power Pa and second power Pb is equal to or less than the discharge power limit value Wout of the power storage device, determining the transmission gear position as a target transmission gear position; executing control for shifting a transmission gear position to the determined transmission gear position; and executing control for stopping the engine.

### CROSS-REFERENCE TO RELATED APPLICATIONS

This nonprovisional application claims priority to Japanese Patent Application No. 2015-178345 filed on Sep. 10, 2015, with the Japan Patent Office, the entire contents of which are hereby incorporated by reference.

### BACKGROUND

Field

The present disclosure relates to engine stop control in a hybrid vehicle including an engine, a motor generator capable of exerting a torque on an output shaft of the engine, and a transmission.

Description of the Background Art

A hybrid vehicle including an engine and a motor generator capable of exerting a torque on an output shaft of the engine is known. As to such a hybrid vehicle, for example, WO02/04806 discloses a technique for changing the rotation position of the output shaft of the engine to a prescribed position by rotating the output shaft of the engine using a motor generator in a fuel cut state.

### SUMMARY

When rotation of the output shaft of the engine is stopped during traveling of such a hybrid vehicle, the motor generator is operated such that the rotation speed of the engine immediately passes through a resonance range, with the result that the rotation speed of the engine can be reduced. Thereby, occurrence of vibration and shock is suppressed. In order to operate the motor generator, electric power may need to be supplied from a power storage device such as a battery to the motor generator. However, when the total power (obtained by adding the power required for operating the motor generator as described above to the power required for driving the vehicle) exceeds an upper limit value of the discharge power from the power storage device, the driving force for the vehicle, the operation of the motor generator and the like may be restricted. Consequently, the drivability of the vehicle may deteriorate.

Some embodiments provide a hybrid vehicle in which the rotation speed of the engine is immediately reduced when the engine is stopped.

A hybrid vehicle according to an aspect of the present disclosure includes an engine, a first motor generator, a second motor generator, a transmission, a differential, a power storage device, and a controller. The second motor generator is configured to output motive power to a driving wheel of the vehicle. The transmission includes a plurality of gear positions, and is provided between the driving wheel and the second motor generator. The differential includes (i) a first rotating element connected to the first motor generator, (ii) a second rotating element connected to the second motor generator, and (iii) a third rotating element connected to an output shaft of the engine. The differential is configured such that, when rotation speeds of two rotating elements among the first rotating element, the second rotating element and the third rotating element are determined, a rotation speed of one remaining rotating element is determined. The power storage device transmits and receives electric power to and from each of the first motor generator and the second motor generator. The controller is configured to, when rotation of the output shaft of the engine is stopped using the first motor generator during traveling of the vehicle, (i) shift a gear position of the transmission so as to decrease a sum of first power required for operating the first motor generator and second power required for driving the driving wheel, and (ii) reduce a rotation speed of the engine using the first motor generator.

In this way, the gear position of the transmission is shifted so as to decrease the first power required for operating the first motor generator in order to reduce the rotation speed of the engine. Accordingly, the total power required for the vehicle can be suppressed from exceeding the upper limit value of the discharge power of the power storage device. Consequently, the rotation speed of the engine can be immediately reduced. Therefore, deterioration of the drivability can be suppressed.

In some embodiments, the controller is configured to shift the gear position of the transmission so as to decrease the first power when rotation of the output shaft of the engine is stopped using the first motor generator during traveling of the vehicle and when the sum of the first power and the second power at a current gear position exceeds an upper limit value of discharge power of the power storage device.

When the sum of the first power and the second power exceeds the upper limit value of the discharge power of the power storage device, the gear position of the transmission is shifted so as to decrease the first power, so that the sum of the first power and the second power can be decreased. Consequently, when the sum of the first power and the second power is equal to or less than the upper limit value of the discharge power of the power storage device, the rotation speed of the engine can be immediately reduced using the first motor generator.

In some embodiments, the controller is configured to shift the gear position to a first gear position as a target gear position when rotation of the output shaft of the engine is stopped using the first motor generator during traveling of the vehicle, and when the sum of the first power and the second power at the first gear position as a target gear position is equal to or less than an upper limit value of discharge power of the power storage device.

By shifting the gear position to the first gear position, the sum of the first power and the second power can be set to be equal to or less than the upper limit value of the discharge power of the power storage device. Accordingly, the rotation speed of the engine can be immediately reduced using the first motor generator.

In some embodiments, the controller is configured to, when rotation of the output shaft of the engine is stopped using the first motor generator during traveling of the vehicle, determine, as a target gear position, a gear position that is closest to a current gear position and at which the sum of the first power and the second power is equal to or less than an upper limit value of discharge power of the power storage device.

By shifting the gear position to the gear position determined as a target gear position, the sum of the first power and the second power can be set to be equal to or less than the upper limit value of the discharge power of the power storage device. Furthermore, since the gear position determined as a target gear position is closest to the current gear position, an increase in the number of gear shifting times can be suppressed.

In some embodiments, the controller is configured to, when rotation of the output shaft of the engine is stopped using the first motor generator during traveling of the vehicle, determine, as a target gear position, a gear position exhibiting the smallest first power among the plurality of gear positions.

By shifting the gear position to a gear position determined as a target gear position, the smallest first power can be achieved. Accordingly, the sum of the first power and the second power can be decreased.

In some embodiments, the controller is configured to determine, as a target gear position, a gear position that is adjacent to a current gear position and at which the sum of the first power and the second power is smaller than the sum of the first power and the second power at the current gear position.

By shifting the gear position to the adjacent gear position determined as a target gear position, the sum of the first power and the second power can be decreased while suppressing an increase in the number of gear shifting times.

The foregoing and other features, aspects and advantages of the present disclosure will become more apparent from the following detailed description when taken in conjunction with the accompanying drawings.

### BRIEF DESCRIPTION OF THE DRAWINGS

FIG. 1 is a schematic configuration diagram of a power transmitting system and a control system thereof in a vehicle.

FIG. 2 is a diagram showing main signals and commands that are input into and output from a controller.

FIG. 3 is a diagram showing respective configurations of a differential and a transmission.

FIG. 4 is a diagram showing an engagement operation table of the transmission.

FIG. 5 is a collinear diagram of a transmission unit formed of the differential and the transmission.

FIG. 6 is a collinear diagram showing changes in rotation speeds of an engine and motor generators when the engine is stopped.

FIG. 7 is a functional block diagram of the controller.

FIG. 8 is a flowchart showing a controlling process executed by the controller.

FIG. 9 is a collinear diagram showing changes in rotation speeds of the differential and the transmission unit when the engine is stopped.

FIG. 10 is a diagram for illustrating the operation of the controller.

FIG. 11 is a first flowchart showing a controlling process executed by the controller in a modification.

FIG. 12 is a second flowchart showing the controlling process executed by the controller in the modification.

FIG. 13 is a third flowchart showing the controlling process executed by the controller in the modification.

### DETAILED DESCRIPTION

Embodiments of the present disclosure will be hereinafter described with reference to the accompanying drawings. In the following description, the same components are designated by the same reference characters. Names and functions thereof are also the same. Therefore, detailed description thereof will not be repeated.

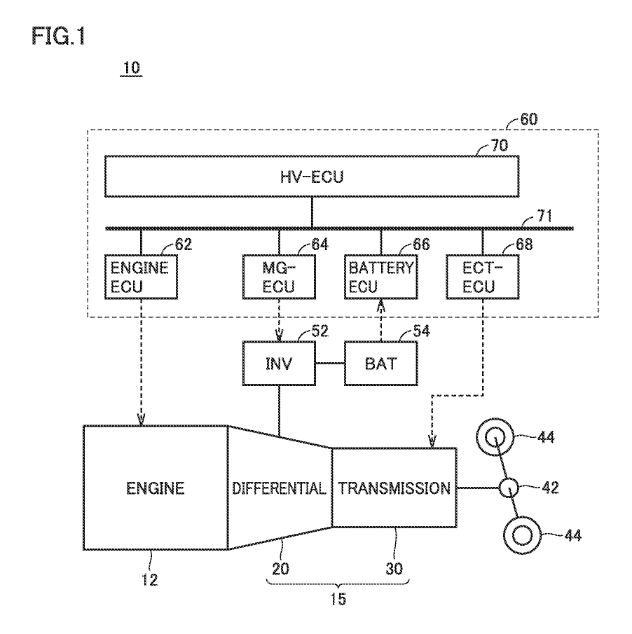

As shown in FIG. 1, a vehicle 10 includes an engine 12, a transmission unit 15, a differential gear mechanism 42, and driving wheels 44. Transmission unit 15 includes a differential 20 and a transmission 30. Moreover, vehicle 10 further includes an inverter 52, a power storage device 54, and a controller 60. Vehicle 10 is a hybrid vehicle employing engine 12 and a motor generator MG2 as driving sources as described below.

Engine 12 is an internal combustion engine configured to generate motive power by converting (i) heat energy resulting from combustion of fuel into (ii) kinetic energy for moving elements such as a piston and a rotor. Differential 20 is coupled to engine 12. Differential 20 includes: a motor generator driven by inverter 52; and a power split device configured to split the output of engine 12 for a transfer member leading to transmission 30 and for the motor generator. Differential 20 is configured to be capable of continuously changing a ratio (transmission gear ratio) of the rotation speed of the output shaft of engine 12 and the rotation speed of the transfer member connected to transmission 30, by appropriately controlling an operation point of the motor generator. In other words, differential 20 serves as a continuously variable transmission. Details of the configuration of differential 20 will be described later.

Transmission 30 is coupled to differential 20. Transmission 30 is configured to be capable of changing a ratio (transmission gear ratio) of the rotation speed of the transfer member (input shaft of transmission 30) connected to differential 20 and the rotation speed of the driving shaft (output shaft of transmission 30) connected to differential gear mechanism 42. Transmission 30 may be an automatic transmission capable of transferring motive power in a predetermined manner (capable of operating transmission 30) by engaging a friction engagement element (clutch), which is actuated with hydraulic pressure. Transmission 30 may be a gear-type automatic transmission capable of changing the transmission gear ratio in a step-wise manner by engaging or disengaging a plurality of friction engagement elements (clutches and brakes), which are actuated with hydraulic pressure, in a predetermined combination, for example. Alternatively, transmission 30 may be a continuously variable automatic transmission that has a starting clutch and that is capable of continuously changing the transmission gear ratio.

Moreover, the transmission gear ratio of transmission unit 15 (total transmission gear ratio between the driving shaft and the output shaft of engine 12) is determined by the transmission gear ratio of transmission 30 and the transmission gear ratio of differential 20. It should be noted that the detailed configuration of transmission 30 will be also described together with differential 20. Differential gear mechanism 42 is coupled to the output shaft of transmission 30 and transfers motive power from transmission 30 to driving wheels 44.

Inverter 52 is controlled by controller 60 to control driving of the motor generator included in differential 20. Inverter 52 is formed of a bridge circuit including three-phase power semiconductor switching elements, for example. It should be noted that although not shown particularly, a voltage converter may be provided between inverter 52 and power storage device 54.

Power storage device 54 is a rechargeable DC power source and is representatively formed of a secondary battery such as a lithium-ion battery or a nickel-metal hydride battery. It should be noted that instead of the secondary battery, power storage device 54 may be formed of a power storage element such as an electric double layer capacitor.

Controller 60 includes an engine ECU (Electronic Control Unit) 62, an MG-ECU 64, a battery ECU 66, an ECT-ECU 68, and an HV-ECU 70. Each of these ECUs includes a CPU (Central Processing Unit), a storage device, an input/output buffer, and the like (all of which are not shown). Each ECU performs predetermined control. Processing for the control performed by each ECU is not limited to software processing, and can be implemented by dedicated hardware (electronic circuit). Each ECU is connected to a communication line (bus) 71 to send/receive a signal thereto/therefrom.

Engine ECU 62 generates a control signal for driving engine 12, based on an engine torque command or the like received from HV-ECU 70. Engine ECU 62 outputs the generated control signal to engine 12. MG-ECU 64 generates a control signal for driving inverter 52, and outputs the generated control signal to inverter 52.

Based on the voltage and/or current of power storage device 54, battery ECU 66 estimates a state of charge (represented by an SOC (State Of Charge) value, which indicates a percentage of an amount of stored electric power at present relative to that in the fully charged state) of power storage device 54. Battery ECU 66 outputs the estimated value to HV-ECU 70. Based on a torque capacity command or the like received from HV-ECU 70, ECT-ECU 68 generates a hydraulic pressure command for controlling transmission 30, and outputs the generated hydraulic pressure command to transmission 30.

HV-ECU 70 receives signals from a shift lever sensor and various other sensors, and generates various commands for controlling devices of vehicle 10. As representative control performed by HV-ECU 70, HV-ECU 70 performs traveling control based on an amount of operation on an accelerator pedal, vehicle speed, or the like to control engine 12 and transmission unit 15 to be brought into a desired state for traveling. Moreover, HV-ECU 70 performs gear shift control based on a traveling state of the vehicle (accelerator position, vehicle speed, or the like), a position of the shift lever, or the like to control differential 20 and transmission 30 to be brought into a desired transmission state. Details of this gear shift control will be described later.

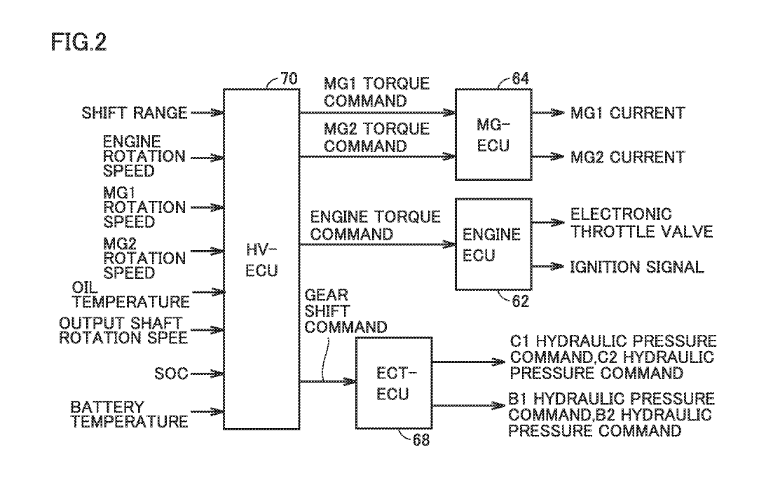

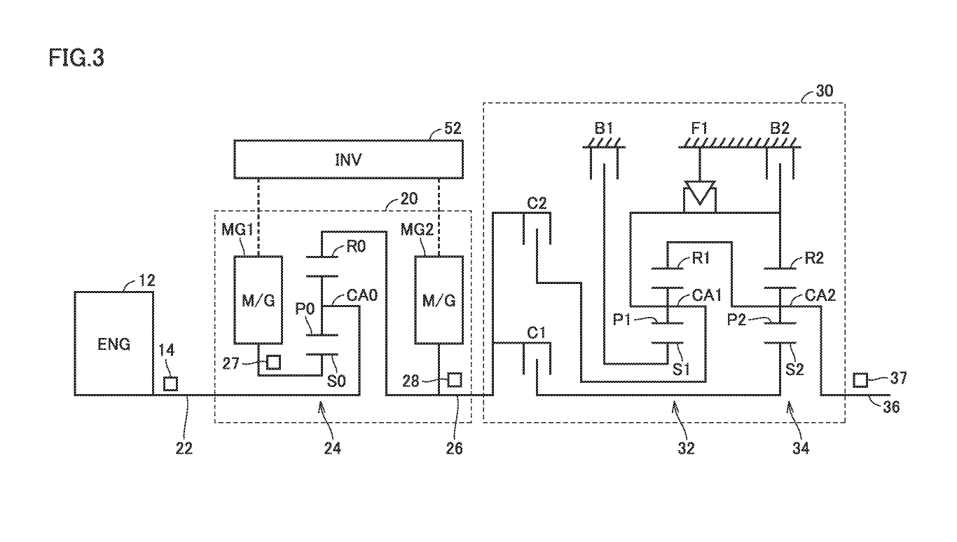

FIG. 2 is a diagram showing main signals and commands that are input into and output from controller 60 shown in FIG. 1. Referring to FIG. 2, HV-ECU 70 receives a signal from a shift range sensor that detects a shift range, and a signal from an engine rotation speed sensor 14 (see FIG. 3) that detects a rotation speed Ne of engine 12. The shift range includes, for example, a forward traveling (D) range, a backward traveling (R) range, and a neutral (N) range. For example, the shift range sensor may detect the position of the shift lever, or may be a sensor (neutral start switch) that is provided within transmission 30 and detects the position of the member moved to a position corresponding to the shift range selected according to the shift lever operation.

Furthermore, HV-ECU 70 further receives: a signal from an MG1 rotation speed sensor 27 (see FIG. 3) for detecting a rotation speed Nm1 of motor generator MG1 (described later) included in differential 20; a signal from an MG2 rotation speed sensor 28 (see FIG. 3) for detecting a rotation speed Nm2 of motor generator MG2 (described later) included in differential 20; a signal from an output shaft rotation speed sensor 37 (see FIG. 3) for detecting a rotation speed No of the output shaft of transmission 30 (which will be hereinafter referred to as an output shaft rotation speed); and a signal from an oil temperature sensor for detecting the temperature (oil temperature) of ATF (Automatic Transmission Fluid) in each of differential 20 and transmission 30. Furthermore, HV-ECU 70 receives, from battery ECU 66, a signal showing an SOC value of power storage device 54 and a signal showing the temperature of power storage device 54 (battery temperature).

When controlling the charge amount and the discharge amount of power storage device 54, HV-ECU 70 sets, based on a battery temperature TB and the current SOC: an upper limit value of the input electric power (charge power) permitted during charge of power storage device 54 (which will be hereinafter referred to as a “charge power limit value Win”); and an upper limit value of the output electric power (discharge power) permitted during discharge of power storage device 54 (which will be hereinafter referred to as a “discharge power limit value Wout”). For example, discharge power limit value Wout is set to be gradually decreased when the current SOC decreases. On the other hand, charge power limit value Win is set to be gradually decreased when the current SOC increases. In the present disclosure, discharge power limit value Wout and charge power limit value Win each are described as a positive value for convenience of explanation, however discharge power limit value Wout may be defined as a positive value and charge power limit value Win may be defined as a negative value.

Furthermore, a secondary battery used as power storage device 54 has temperature dependency by which internal resistance rises at a low temperature. Furthermore, it may be necessary to prevent the temperature from excessively rising due to further heat generation. Accordingly, in some embodiments each of discharge power limit value Wout and charge power limit value Win is lowered both at a low battery temperature and at a high battery temperature. HV-ECU 70 sets charge power limit value Win and discharge power limit value Wout in accordance with battery temperature TB and current SOC, for example, by using a map or the like.

HV-ECU 70 transmits, to MG-ECU 64, a signal showing a torque command (MG1 torque command) for motor generator MG1 and a signal showing a torque command (MG2 torque command) for motor generator MG2. HV-ECU 70 transmits, to engine ECU 62, a signal showing a torque command (engine torque command) for engine 12. Furthermore, HV-ECU 70 transmits, to ECT-ECU 68, a signal showing a gear shift command for transmission 30.

Based on the engine torque command, engine ECU 62 generates a throttle signal, an ignition signal, a fuel injection signal and the like for driving engine 12, and then outputs the generated signals to engine 12. Based on the MG1 torque command and the MG2 torque command, MG-ECU 64 generates an MG1 current command value and an MG2 current command value for causing inverter 52 to drive motor generator MG1 and motor generator MG2, respectively, and then outputs these generated command values to inverter 52. Based on the gear shift command, ECT-ECU 68 generates a hydraulic pressure command such that transmission 30 has a torque capacity corresponding to a torque capacity command Tcr. Then, ECT-ECU 68 outputs the generated hydraulic pressure command to transmission 30.

FIG. 3 shows respective configurations of differential 20 and transmission 30 shown in FIG. 1. It should be noted that in FIG. 3, each of differential 20 and transmission 30 is configured to be symmetrical with respect to the axial center. Hence, in FIG. 3, illustration of lower portions of differential 20 and transmission 30 is omitted.

Referring to FIG. 3, differential 20 includes motor generators MG1, MG2, and a power split device 24. Each of motor generators MG1 and MG2 is an AC (alternating-current) motor, such as a permanent-magnet type synchronous motor including a rotor having a permanent magnet embedded therein. Motor generators MG1 and MG2 are driven by inverter 52.

Motor generator MG1 is provided with MG1 rotation speed sensor 27 configured to detect a rotation speed Nm1 of the rotation shaft of motor generator MG1. Motor generator MG2 is provided with MG2 rotation speed sensor 28 configured to detect a motor rotation speed Nm2.

Power split device 24 is formed of a single pinion type planetary gear, and includes a sun gear S0, a pinion gear P0, a carrier CA0, and a ring gear R0. Carrier CA0 is coupled to an input shaft 22, i.e., the output shaft of engine 12, and supports pinion gear P0 rotatably and revolvably. Sun gear S0 is coupled to the rotation shaft of motor generator MG1. Ring gear R0 is configured to be coupled to transfer member 26 and be engaged with sun gear S0 via pinion gear P0. The rotation shaft of motor generator MG2 is connected to transfer member 26. That is, ring gear R0 is also connected to the rotation shaft of motor generator MG2.

Power split device 24 serves as a differential by rotating sun gear S0, carrier CA0 and ring gear R0 relative to one another. With the differential function of power split device 24, motive power output from engine 12 is distributed to sun gear S0 and ring gear R0. Motor generator MG1 operates as an electric power generator using the motive power distributed to sun gear S0. Electric power generated by motor generator MG1 is supplied to motor generator MG2 or is stored in power storage device 54 (FIG. 1). Motor generator MG1 generates electric power using motive power split by power split device 24, and motor generator MG2 is driven using electric power generated by motor generator MG1. Accordingly, differential 20 can implement a transmission function.

Transmission 30 includes single pinion type planetary gears 32, 34, clutches C1, C2, brakes B1, B2, and a one-way clutch F1. Planetary gear 32 includes a sun gear S a pinion gear P1, a carrier CA1, and a ring gear R1. Planetary gear 34 includes a sun gear S2, a pinion gear P2, a carrier CA2, and a ring gear R2.

Each of clutches C1, C2 and brakes B1, B2 is a friction engagement device configured to operate using a hydraulic pressure. Clutches C1, C2 and brakes B1, B2 are formed of: a multiplate wet type in which a plurality of overlapped friction plates are pressed by way of hydraulic pressure; a band brake in which one end of a band wound around the outer circumferential surface of a rotating drum is tightened by hydraulic pressure; and the like. One-way clutch F1 supports carrier CA1 and ring gear R2, which are connected to each other, such that they can be rotated in one direction and cannot be rotated in the other direction.

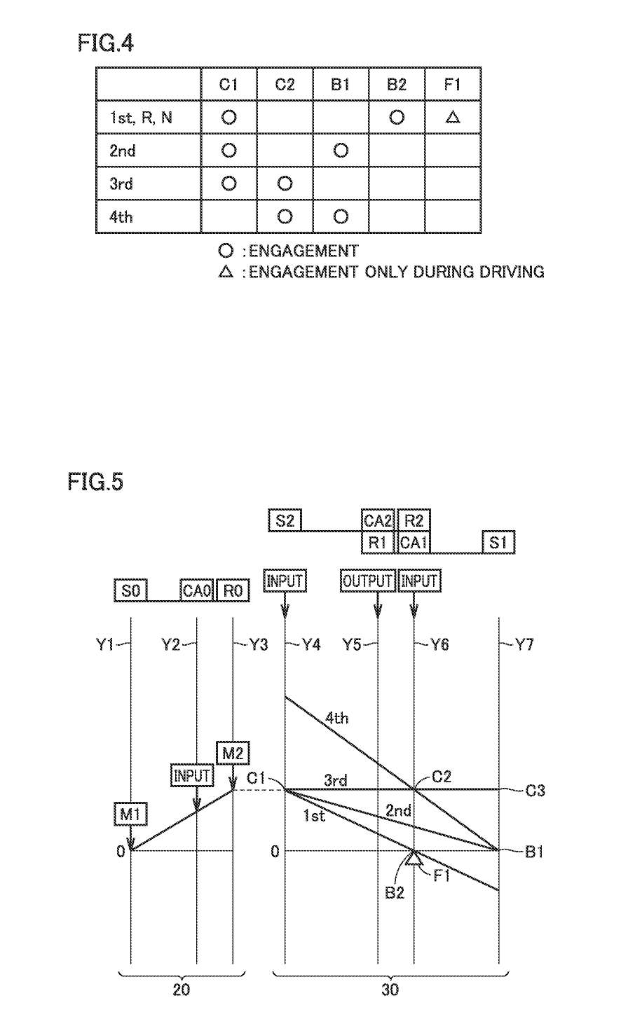

In this transmission 30, the respective engagement devices, i.e., clutches C1, C2, brakes B1, B2, and one-way clutch F1 are engaged in accordance with an engagement operation table shown in FIG. 4, thereby selectively forming first to fourth gear positions and a reverse gear position. It should be noted that in FIG. 4, a circle mark represents an engagement state, a triangle mark represents that engagement is attained only during driving, and a blank represents a disengagement state. Also in some embodiments, an N range is selected as a shift range. When power storage device 54 is not charged, transmission 30 is brought into a state where, similar to the first gear position, clutch C1 and brake B1 are engaged and the torque outputs from motor generators MG1 and MG2 are stopped. When the torque outputs from motor generators MG1 and MG2 are stopped, a neutral state (state in which transfer of motive power is blocked) is formed.

On the other hand, when the N range is selected as a shift range and power storage device 54 is charged, in transmission 30, clutch C1 is brought into a disengagement state, thereby forming a neutral state (state in which transfer of motive power is blocked). When power storage device 54 is charged, engine 12 is brought into an operated state, and a negative torque is generated in each of motor generators MG1 and MG2, thereby performing a power generation operation. In this case, brake B2 is maintained in the engagement state.

Again referring to FIG. 3, differential 20 and transmission 30 are coupled to each other by transfer member 26. Then, output shaft 36 coupled to carrier CA2 of planetary gear 34 is coupled to differential gear mechanism 42 (FIG. 1). Output shaft 36 of transmission 30 is provided with an output shaft rotation speed sensor 37, which is configured to detect an output shaft rotation speed No.

FIG. 5 is a collinear diagram of transmission unit 15 formed of differential 20 and transmission 30. Referring to FIG. 3 together with FIG. 5, a vertical line Y1 in the collinear diagram corresponding to differential 20 shows the rotation speed of sun gear S0 in power split device 24, that is, shows the rotation speed of motor generator MG1. A vertical line Y2 shows the rotation speed of carrier CA0 in power split device 24, that is, shows the rotation speed of engine 12. A vertical line Y3 shows the rotation speed of ring gear R0 in power split device 24, that is, shows the rotation speed of motor generator MG2. It is to be noted that the distances among vertical lines Y1 to Y3 are determined in accordance with the gear ratio of power split device 24.

Furthermore, a vertical line Y4 in the collinear diagram corresponding to transmission 30 shows the rotation speed of sun gear S2 in planetary gear 34. A vertical line Y5 shows the rotation speeds of carrier CA2 in planetary gear 34 and ring gear R1 in planetary gear 32 that are coupled to each other. A vertical line Y6 shows the rotation speeds of ring gear R2 in planetary gear 34 and carrier CA1 in planetary gear 32 that are coupled to each other. A vertical line Y7 shows the rotation speed of sun gear S1 in planetary gear 32. The distances among vertical lines Y4 to Y7 are determined in accordance with the gear ratio between planetary gears 32 and 34.

When clutch C1 is engaged, sun gear S2 of planetary gear 34 is coupled to ring gear R0 of differential 20, and sun gear S2 rotates at the same speed as that of ring gear R0. When clutch C2 is engaged, carrier CA1 of planetary gear 32 and ring gear R2 of planetary gear 34 are coupled to ring gear R0, and carrier CA1 and ring gear R2 rotate at the same speed as that of ring gear R0. When brake B1 is engaged, rotation of sun gear S1 is stopped. When brake B2 is engaged, rotation of each of carrier CA1 and ring gear R2 is stopped.

For example, when clutch C1 and brake B1 are engaged and other clutches and brakes are disengaged as shown in the engagement operation table of FIG. 4, the collinear diagram of transmission 30 is represented as a straight line shown by “2nd”. Vertical line Y5 showing the rotation speed of carrier CA2 in planetary gear 34 shows the output rotation speed of transmission 30 (the rotation speed of output shaft 36). Thus, by engaging or disengaging clutches C1, C2 and brakes B1, B2 in transmission 30 in accordance with the engagement operation table in FIG. 4, the first to fourth gear positions, the reverse gear position, and the neutral state can be formed.

On the other hand, in differential 20, rotation of each of motor generators MG1, MG2 is controlled as appropriate. Thereby, continuously variable transmission is implemented in which the rotation speed of ring gear R0, that is, the rotation speed of transfer member 26 can be changed continuously with respect to the rotation speed of engine 12 coupled to carrier CA0. To such differential 20, transmission 30, which is capable of changing the transmission gear ratio between transfer member 26 and output shaft 36, is connected. Accordingly, the continuously variable transmission function by differential 20 can be provided while attaining a small transmission gear ratio of differential 20. As a result, loss in motor generators MG1, MG2 can be reduced.

In order to stop rotation of the output shaft of engine 12 during traveling of vehicle 10 including the above-described configuration, motor generator MG1 is operated such that the rotation speed of engine 12 immediately passes through the resonance range, to reduce the rotation speed of engine 12. Thereby, occurrence of vibration and shock is suppressed. By operating motor generator MG1, motor generator MG1 may consume electric power.

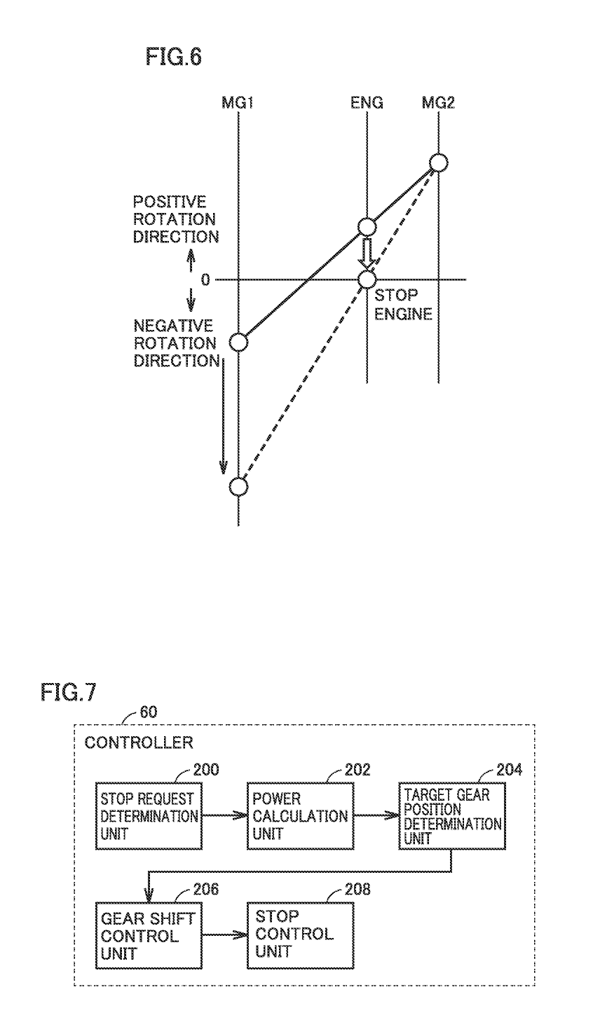

FIG. 6 shows a collinear diagram illustrating the relation among the rotation speeds of motor generator MG1, engine 12 and motor generator MG2. For example, as shown by a collinear line (solid line) in FIG. 6, it is assumed that engine 12 is requested to be stopped when motor generators MG1, MG2 and engine 12 are operated. When the vehicle speed is constant, the rotation speed of motor generator MG2 is also constant. Accordingly, in order to reduce the rotation speed of engine 12, the operation of motor generator MG1 is controlled so as to generate a torque in the negative rotation direction. As the torque in the negative rotation direction is generated in motor generator MG1, the rotation speed of motor generator MG1 increases in the negative rotation direction. Thereby, the rotation speed of engine 12 is reduced. Then, as shown by a collinear line (dashed line) in FIG. 6, the rotation speed of motor generator MG1 is increased in the negative rotation direction until the rotation speed of engine 12 reaches zero.

When the rotation speed of motor generator MG1 is increased in the negative rotation direction until the rotation speed of engine 12 reaches zero in the state where the rotation speed of motor generator MG2 is constant, a torque is generated in the negative rotation direction, and the rotation speed in the same negative rotation direction increases. Accordingly, electric power is to be consumed in motor generator MG1.

However, when the total power (obtained by adding the power required for operating motor generator MG1 as described above to the power required for driving the driving wheel 44 of vehicle 10) exceeds the upper limit value of the discharge power of power storage device 54, the driving force of vehicle 10, the operation of motor generator MG1, and the like may be limited. Accordingly, the drivability of vehicle 10 may deteriorate.

Thus, in some embodiments, when controller 60 stops rotation of the output shaft of engine 12 using motor generator MG1 during traveling of vehicle 10, the transmission gear position of transmission 30 is shifted so as to decrease the sum of the first power required for operating motor generator MG1 and the second power required for driving the driving wheel, and then, the rotation speed of engine 12 is reduced using motor generator MG1.

In this way, the total power required for vehicle 10 can be suppressed from exceeding the upper limit value of the discharge power of power storage device 54. As a result, the engine rotation speed can be reduced immediately.

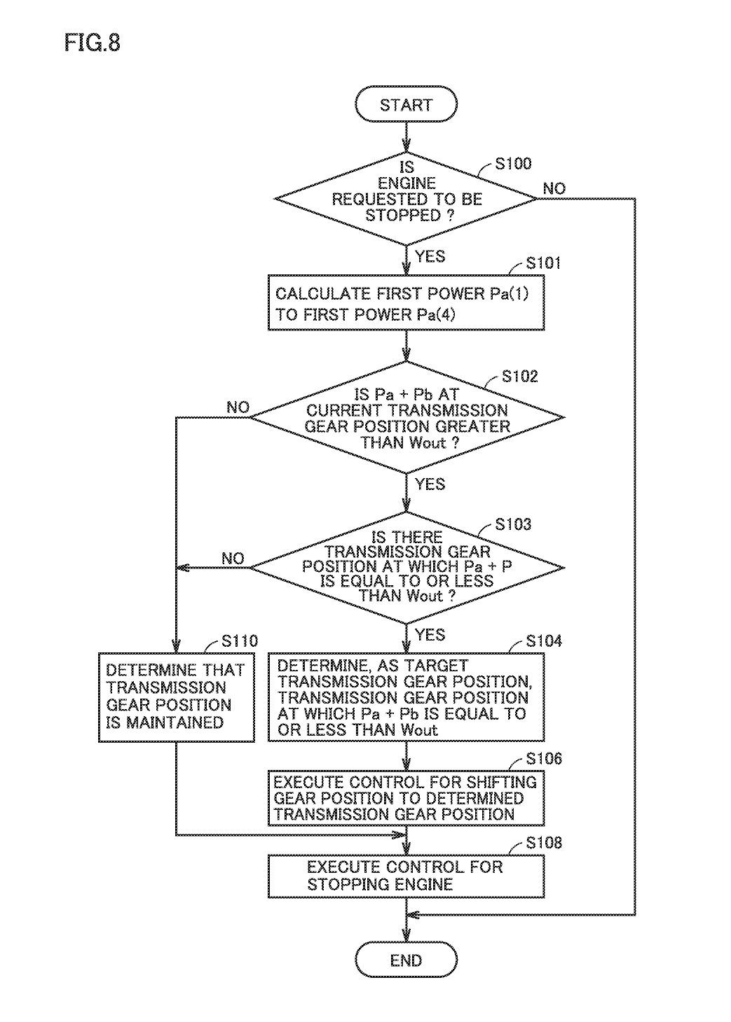

FIG. 7 shows a functional block diagram of controller 60 included in vehicle 10. Controller 60 includes a stop request determination unit 200, a power calculation unit 202, a target gear position determination unit 204, a gear shift control unit 206, and a stop control unit 208. It should be noted that these configurations may be implemented by software such as a program, or may be implemented by hardware. It should be also noted that these configurations may be implemented by at least one of engine ECU 62, MG-ECU 64, battery ECU 66, ECT-ECU 68, and HV-ECU 70 described above. For example, these configurations may be implemented only by HV-ECU 70 or may be implemented by engine ECU 62 and HV-ECU 70.

Stop request determination unit 200 determines whether engine 12 is requested to be stopped or not. For example, when engine 12 is being operated, stop request determination unit 200 determines whether a condition for stopping engine 12 is satisfied or not. When the condition for stopping engine 12 is satisfied, stop request determination unit 200 determines that the engine is requested to be stopped. The condition for stopping engine 12 includes, for example, at least any one of: a condition that a prescribed traveling mode is selected from a plurality of traveling modes; a condition that power storage device 54 is in a fully-charged state in which the SOC of power storage device 54 is equal to or greater than a threshold value set in accordance with the traveling mode; and a condition that the power required for vehicle 10 based on the accelerator pedal position is lower than a start-up threshold value of engine 12 set in accordance with the traveling mode. It is to be noted that the above-described conditions for stopping engine 12 are merely by way of example, and conditions different from the above-described conditions may particularly be included.

Furthermore, a plurality of traveling modes includes, for example: a CD mode in which the SOC of power storage device 54 is actively consumed by primarily executing EV traveling (traveling using only motor generator MG2 as a driving source) while allowing HV traveling (traveling using engine 12 and motor generator MG2 as driving sources); and a CS mode in which the SOC is controlled to fall within a prescribed range by switching the traveling mode between HV traveling and EV traveling as appropriate. The prescribed traveling mode is a CD mode, for example.

When stop request determination unit 200 determines that engine 12 is requested to be stopped, power calculation unit 202 calculates the power required for operating motor generator MG1 (which will be hereinafter referred to as first power Pa) in order to stop the rotation of the output shaft of engine 12 for each transmission gear position including the first gear position to the fourth gear position.

Power calculation unit 202 calculates first power Pa for each transmission gear position, for example, based on the vehicle speed, the rotation speed of engine 12, and the transmission gear ratio corresponding to each transmission gear position. Power calculation unit 202 calculates first power Pa(1) to first power Pa(4) corresponding to the first gear position to the fourth gear position, respectively, for example, based on the vehicle speed, the rotation speed of engine 12, and the map set for each transmission gear position. The map set for each transmission gear position includes a map corresponding to the first gear position, a map corresponding to the second gear position, a map corresponding to the third gear position, and a map corresponding to the fourth gear position. These maps are adapted by experiments and the like, for example.

The map corresponding to the first gear position shows the relation among the vehicle speed, the rotation speed of engine 12, and first power Pa(1) corresponding to the case where the first gear position is selected. The map corresponding to the second gear position shows the relation among the vehicle speed, the rotation speed of engine 12, and first power Pa(2) corresponding to the case where the second gear position is selected. The map corresponding to the third gear position shows the relation among the vehicle speed, the rotation speed of engine 12, and first power Pa(3) corresponding to the case where the third gear position is selected. The map corresponding to the fourth gear position shows the relation among the vehicle speed, the rotation speed of engine 12, and first power Pa(4) corresponding to the case where the fourth gear position is selected.

Based on first power Pa(1) to first power Pa(4) calculated by power calculation unit 202, target gear position determination unit 204 determines a target transmission gear position to be shifted from the current transmission gear position. In some embodiments, target gear position determination unit 204 selects first power Pa at which the sum of first power Pa and the power required for driving the driving wheel 44 (which will be hereinafter referred to as second power Pb) is equal to or less than discharge power limit value Wout of power storage device 54. Then, target gear position determination unit 204 determines, as a target transmission gear position, the transmission gear position that corresponds to this selected first power Pa and that is closest to the current transmission gear position. For example, when the current transmission gear position is the second gear position, and when the sum of first power Pa(3) and second power Pb and the sum of first power Pa(4) and second power Pb are equal to or less than discharge power limit value Wout of power storage device 54, target gear position determination unit 204 selects first power Pa(3), and determines the third gear position corresponding to the selected first power Pa(3) as a target transmission gear position. In addition, target gear position determination unit 204 maintains the current transmission gear position when the sum of first power Pa corresponding to the current transmission gear position and second power Pb is equal to or less than discharge power limit value Wout of power storage device 54.

Target gear position determination unit 204 calculates second power Pb required for driving the driving wheel 44, for example, based on the accelerator pedal position. Target gear position determination unit 204 calculates second power Pb, for example, based on the accelerator pedal position, the vehicle speed, and the prescribed map. The prescribed map shows the relation among the accelerator pedal position, the vehicle speed, and second power Pb, and is for example adapted by experiments and the like.

Gear shift control unit 206 executes gear shift control for shifting the transmission gear position to a transmission gear position determined by target gear position determination unit 204. Specifically, gear shift control unit 206 controls the hydraulic pressure supplied to each of clutches C1, C2 and brakes B1, B2 such that the clutches and the brakes are engaged with each other in combinations corresponding to the determined combinations of transmission gear positions. In addition, gear shift control unit 206 maintains the state of supplying hydraulic pressure to each friction engagement element (clutches C1, C2 and brakes B1, B2) when the current transmission gear position coincides with the determined transmission gear position.

After gear shift control unit 206 completes shifting the transmission gear position to the determined transmission gear position, stop control unit 208 reduces the rotation speed of engine 12 using motor generator MG1. For example, when the transmission gear ratio of transmission 30 calculated based on input shaft rotation speed Nm2 and output shaft rotation speed No of transmission 30 coincides with the transmission gear ratio corresponding to the determined transmission gear position, stop control unit 208 may determine that transmission gear shifting has been completed.

Stop control unit 208 controls the operation of motor generator MG1 so as to generate a prescribed torque in the negative rotation direction in motor generator MG1 in order to reduce the rotation speed of engine 12 at a prescribed change rate.

When the rotation speed of engine 12 reaches zero or when the rotation speed of engine 12 becomes equal to or less than a threshold value that can be substantially determined as zero, stop control unit 208 stops generation of torque in motor generator MG1.

Referring to FIG. 8, the controlling process executed by controller 60 mounted in vehicle 10 according to some embodiments will be hereinafter described.

In step (which will be hereinafter abbreviated as S) 100, controller 60 determines whether engine 12 is requested to be stopped or not. If it is determined that engine 12 is requested to be stopped (YES in S100), the process proceeds to S101. If not (No in S100), the process is ended.

In S101, controller 60 calculates first power Pa(1) to first power Pa(4) corresponding to the first gear position to the fourth gear position. In S102, controller 60 determines whether or not the sum of first power Pa and second power Pb (Pa+Pb) at the current transmission gear position is greater than discharge power limit value Wout of power storage device 54. If it is determined that the sum of first power Pa and second power Pb at the current transmission gear position is greater than discharge power limit value Wout (YES in S102), the process proceeds to S103. If not (NO in S102), the process proceeds to S110.

In S103, controller 60 determines whether or not there is a transmission gear position at which the sum of first power Pa and second power Pb is equal to or less than discharge power limit value Wout. If it is determined that there is a transmission gear position at which the sum of first power Pa and second power Pb is equal to or less than discharge power limit value Wout (YES in S103), the process proceeds to S104. If not (NO in S103), the process proceeds to S110.

In S104, controller 60 determines, as a target transmission gear position, the transmission gear position that is closest to the current transmission gear position and at which the sum of first power Pa and second power Pb is equal to or less than discharge power limit value Wout.

In S106, controller 60 executes gear shift control so as to shift the transmission gear position to a transmission gear position determined as a target transmission gear position. In S108, controller 60 reduces the rotation speed of engine 12 using motor generator MG1 until the rotation speed of engine 12 reaches zero. In S110, controller 60 determines that the transmission gear position is maintained. Controller 60 subsequently causes the process to proceed to S108.

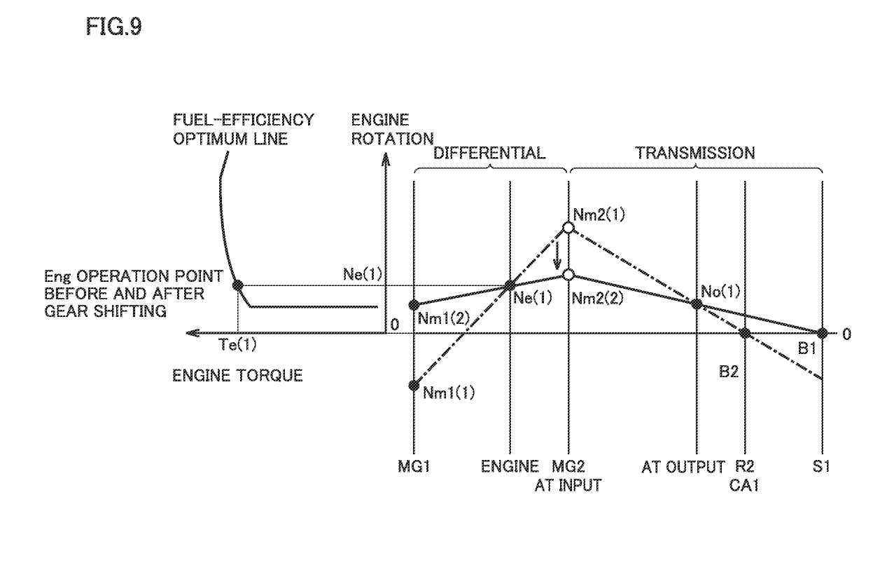

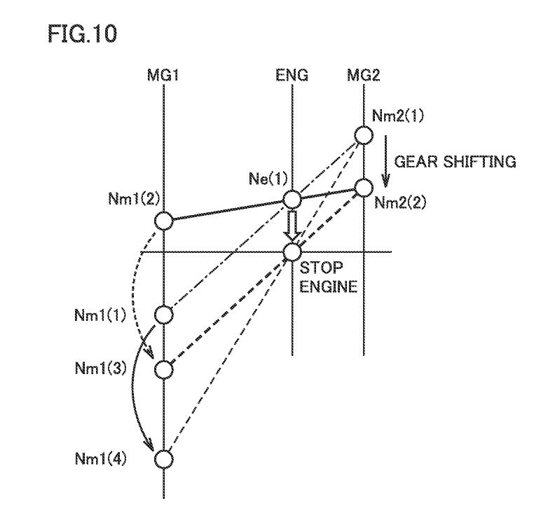

An explanation will be hereinafter given with reference to FIGS. 9 and 10 about the operation of controller 60 mounted in vehicle 10 according to some embodiments based on the above-described structure and flowchart.

FIG. 9 shows a collinear diagram of transmission unit 15 and a diagram illustrating the relation between the rotation speed and the engine torque of engine 12. As shown in FIG. 9, the vertical axis in the figure showing the relation between the rotation speed and the engine torque of engine 12 shows the rotation speed of engine 12 while the horizontal axis shows the engine torque, in which the position on the vertical axis at which the rotation speed of engine 12 reaches zero is positioned on a line extended from the straight line in the lateral direction in FIG. 9. The straight line in the lateral direction in the collinear diagram in FIG. 9 shows that the rotation speed of each rotating element in the collinear diagram is zero. Furthermore, the scale of the vertical axis in the figure showing the relation between the rotation speed and the engine torque of engine 12 is identical to the scale of the vertical axis showing the rotation speed of engine 12 in the collinear diagram.

For example, the following is based on the assumption that vehicle 10 is traveling at a constant speed since the accelerator pedal position is constant. The transmission gear position is the first gear position, and clutch C1 and brake B2 are in an engagement state. Since brake B2 is in an engagement state, rotation of each of ring gear R2 and carrier CA1 in transmission 30 is stopped. In this case, if output shaft rotation speed No of transmission 30 is a rotation speed No(1), rotation speed Nm2 of motor generator MG2 that is also an input shaft rotation speed of transmission 30 becomes a rotation speed Nm2(1). The transmission gear ratio of transmission 30 at this time corresponds to the transmission gear ratio at the first gear position.

Engine 12 is controlled to operate along a predetermined operation line (a fuel-efficiency optimum line) such that the fuel-efficiency characteristics are optimized, as shown by a solid line in the figure showing the relation between the rotation speed and the engine torque of engine 12 in FIG. 9. Accordingly, engine 12 is controlled such that rotation speed Ne of engine 12 reaches rotation speed Ne(1) in order to cause an engine torque Te(1) based on the engine torque command to be generated on the predetermined operation line.

It is assumed that motor generator MG1 rotates in accordance with rotation of engine 12 and rotation of motor generator MG2, and also rotates at a rotation speed Nm1(1) in the negative rotation direction.

For example, if engine 12 is requested to be stopped in vehicle 10 traveling in the above-described state (YES in S100), first power Pa(1) to first power Pa(4) corresponding to the first gear position to the fourth gear position are calculated (S101). Then, if the sum of first power Pa and second power Pb at the current transmission gear position is greater than discharge power limit value Wout (YES in S102), and if there is a transmission gear position at which the sum of first power Pa and second power Pb is equal to or less than discharge power limit value Wout (YES in S103), the transmission gear position that is closest to the current transmission gear position and at which the sum of first power Pa and second power Pb is equal to or less than discharge power limit value Wout is determined as a target transmission gear position (S104). At this time, the second gear position is determined as a target transmission gear position, for example.

Accordingly, control for shifting a gear position to the second gear position is executed (S106). Specifically, the engagement state of clutch C1 is maintained, brake B2 is brought into a disengagement state, and brake B1 is brought into an engagement state, with the result that the second gear position is formed in transmission 30.

When brake B2 is brought into a disengagement state, limitation imposed upon rotation of each of ring gear R2 and carrier CA1 is canceled. When brake B1 is brought into an engagement state, the rotation speed of sun gear S1 is limited to zero. Since output shaft rotation speed No is constant before and after gear shifting, the input shaft rotation speed of transmission 30 is reduced at the second gear position from rotation speed Nm2(1) to rotation speed Nm2(2).

In this case, if the command for the engine torque remains unchanged, the rotation speed of engine 12 is to be maintained at Ne(1). Consequently, the second gear position is formed in transmission 30, so that rotation speed Nm1 of motor generator MG1 is increased from rotation speed Nm1(1) to rotation speed Nm1(2). Rotation speed Nm1 of motor generator MG1 is a rotation speed in the positive rotation direction. Then, after the gear position is shifted to the second gear position, control for stopping engine 12 is executed (S108).

Control for stopping engine 12 will be hereinafter described with reference to FIG. 10. FIG. 10 shows a collinear diagram of differential 20.

As shown by a collinear line (solid line) in FIG. 10, rotation speed Nm2 of motor generator MG2 is reduced from rotation speed Nm2(1) to rotation speed Nm2(2) by shifting the gear position to the second gear position. As a result, rotation speed Nm1 of motor generator MG1 increases from rotation speed Nm1(1) to rotation speed Nm1(2) that is a rotation speed in the positive rotation direction, as described above.

When control for stopping engine 12 is executed in such a state, motor generator MG1 is operated such that the torque in the negative rotation direction is exerted in order to reduce rotation speed Ne of engine 12. Accordingly, rotation speed Nm1 of motor generator MG1 is reduced from rotation speed Nm1(2) to rotation speed Nm1(3). Thereby, rotation speed Ne of engine 12 is reduced from rotation speed Ne(1) to zero. When rotation speed Nm1 of motor generator MG1 is reduced from rotation speed Nm1(2) to rotation speed Nm1(3), the power generation operation is performed until rotation speed Nm1 of motor generator MG1 reaches zero. Accordingly, the generated electric power can be used for the operation of motor generator MG2. On the other hand, electric power is to be consumed during a time period in which rotation speed Nm1 of motor generator MG1 changes from zero to rotation speed Nm1(3). However, as compared with the case where rotation speed Nm1 of motor generator MG1 is changed from rotation speed Nm1(1) to rotation speed Nm1(4) without executing transmission gear shifting as shown by the collinear line (alternate long and short dash line) and the collinear line (thin dashed line) in FIG. 10, the amount of change in rotation speed Nm1 and the changed rotation speed Nm1 are smaller in the case where transmission gear shifting is performed as shown by the collinear line (solid line) and the collinear line (bold dashed line) in FIG. 10, and therefore, the electric power to be consumed is smaller also in this case.

As described above, according to some embodiments, the transmission gear position of transmission 30 is shifted so as to decrease first power Pa required for operating motor generator MG1 in order to reduce the rotation speed of engine 12. Accordingly, the total power (Pa+Pb) required for vehicle 10 can be suppressed from exceeding discharge power limit value Wout of power storage device 54. As a result, the rotation speed of engine 12 can be immediately reduced. Consequently, deterioration of the drivability can be suppressed. Therefore, a hybrid vehicle can be provided, which allows the engine rotation speed to be immediately reduced at the time when the engine is stopped.

Furthermore, in some embodiments, when the sum of first power Pa and second power Pb exceeds discharge power limit value Wout of power storage device 54, the transmission gear position of transmission 30 is shifted so as to decrease first power Pa, with the result that the sum of first power Pa and second power Pb can be decreased. Consequently, the sum of first power Pa and second power Pb becomes equal to or less than discharge power limit value Wout of power storage device 54, so that rotation speed Ne of engine 12 can be immediately reduced using motor generator MG1.

Furthermore, in some embodiments, when rotation of the output shaft of engine 12 is stopped using motor generator MG1 during traveling of vehicle 10, controller 60 shifts the transmission gear position to a target transmission gear position at the time when the sum of first power Pa at this target transmission gear position and second power Pb required for driving the driving wheel 44 is equal to or less than discharge power limit value Wout of power storage device 54.

In this way, by shifting the transmission gear position to a target transmission gear position, the sum of first power Pa and second power Pb can be set to be equal to or less than discharge power limit value Wout of power storage device 54. Accordingly, the rotation speed of engine 12 can be immediately reduced using motor generator MG1.

Furthermore, in some embodiments, when rotation of the output shaft of engine 12 is stopped using motor generator MG1 during traveling of vehicle 10, controller 60 determines, as a target transmission gear position, the transmission gear position that is closest to the current transmission gear position and at which the sum of first power Pa and second power Pb required for driving the driving wheel 44 is equal to or less than discharge power limit value Wout of power storage device 54.

In this way, by shifting the transmission gear position to the transmission gear position determined as a target transmission gear position, the sum of first power Pa and second power Pb can be set to be equal to or less than discharge power limit value Wout of power storage device 54. Since the transmission gear position determined as a target transmission gear position is closest to the current transmission gear position, an increase in the number of gear shifting times can be suppressed. Accordingly, deterioration of the drivability can be suppressed.

Modifications will be hereinafter described.

In the above-described embodiments, an explanation has been given with regard to the case where, during control for stopping engine 12, motor generator MG1 is controlled in such a manner that a constant torque is generated in motor generator MG1 until the rotation speed of engine 12 reaches zero. However, for example, the torque of motor generator MG1 may be increased temporarily by a predetermined amount during a time period in which the rotation speed of engine 12 passes through a resonance range. This allows the rotation speed of engine 12 to immediately pass through the resonance range.

Although transmission 30 has been explained as a gear-type automatic transmission in the above-described embodiments, transmission 30 may be a continuously variable automatic transmission such as a belt-type continuously variable transmission, for example. In this case, transmission 30 may be controlled to shift a transmission gear ratio corresponding to the smallest first power Pa among a plurality of first powers Pa calculated at a plurality of transmission gear ratios set in a discrete manner. Alternatively, transmission 30 may be controlled such that the sum of first power Pa and second power Pb becomes equal to or less than discharge power limit value Wout of power storage device 54, and that the transmission gear ratio is shifted to a transmission gear ratio exhibiting the smallest change amount from the current gear ratio.

In the above-described embodiments, power calculation unit 202 has been described as calculating first power Pa(1) to first power Pa(4) corresponding to the first gear position to the fourth gear position using the vehicle speed, the rotation speed of engine 12, and the map for each transmission gear position. However, for example, power calculation unit 202 may calculate first power Pa(1) to first power Pa(4) by a prescribed computing process based on the transmission gear position, the vehicle speed, and the rotation speed of engine 12 as parameters.

For example, based on the target value of the decrease rate (angular acceleration) of rotation speed Ne of engine 12 and the inertia moment of the output shaft of engine 12, power calculation unit 202 calculates a torque required for reducing rotation speed Ne of engine 12 in accordance with this target value. Power calculation unit 202 calculates a torque of motor generator MG1 required for exerting the calculated torque upon the output shaft of engine 12. On the other hand, power calculation unit 202 calculates rotation speed Nm2 of motor generator MG2 in each of the first gear position to the fourth gear position based on the vehicle speed and the transmission gear ratio. Based on the calculated rotation speed of motor generator MG2 and rotation speed Ne of engine 12, power calculation unit 202 calculates rotation speed Nm1 of motor generator MG1 obtained when each of the first gear position to the fourth gear position is formed. Power calculation unit 202 may calculate first power Pa(1) to first power Pa(4) based on the calculated torque of motor generator MG1 and rotation speed Nm1 of motor generator MG1 obtained when each of the first gear position to the fourth gear position is formed.

In this way, the target value of the decrease rate can be set in accordance with the state of vehicle 10. Accordingly, for example, in a high vehicle speed region in which the vehicle speed is higher than a threshold value, vibration and shock are less likely to be recognized by vehicle occupants. Accordingly, the decrease rate may be reduced to decrease the magnitude of first power Pa. Furthermore, in a low vehicle speed region in which the vehicle speed is lower than the threshold value, vibration and shock are more likely to be recognized by vehicle occupants. Accordingly, the decrease rate may be increased to thereby cause the rotation speed to immediately pass through the resonance range.

In the above-described embodiments, an explanation has been given with regard to the cases where the sum of first power Pa and second power Pb is equal to or less than discharge power limit value Wout of power storage device 54 and where the transmission gear position closest to the current transmission gear position is determined as a target transmission gear position. However, the method of determining a target transmission gear position is not particularly limited to the above-described determination method.

Examples of the method of determining a target transmission gear position may be a method of (i) determining in a predetermined order whether the sum of first power Pa and second power Pb in each transmission gear position is equal to or less than discharge power limit value Wout, and (ii) determining, as a target transmission gear position, the transmission gear position at which the sum of first power Pa and second power Pb is first determined as being equal to or less than discharge power limit value Wout.

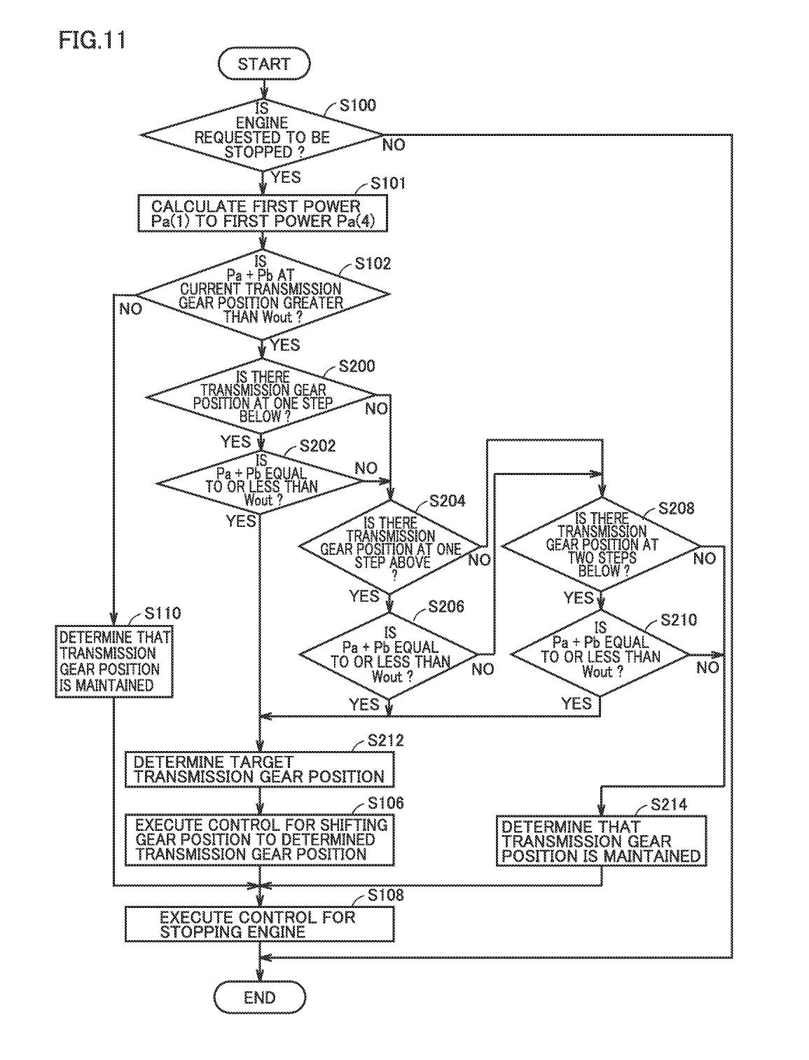

Specifically, controller 60 may execute the controlling process as shown in FIG. 11. It is to be noted that the processes in S100 to S102, S106, S108, and S110 in the flowchart in FIG. 11 are the same as those in S100 to S102, S106, S108, and S110 in the flowchart in FIG. 8. Accordingly, detailed description thereof will not be repeated.

If it is determined in S102 that the sum of first power Pa and second power Pb at the current transmission gear position is greater than discharge power limit value Wout, controller 60 determines in S200 whether there is a transmission gear position at one stage below the current transmission gear position. In some embodiments, for example, if the current transmission gear position is one of the second gear position to the fourth gear position, controller 60 determines that there is a transmission gear position at one stage below the current transmission gear position. If the current transmission gear position is the first gear position, controller 60 determines that there is no transmission gear position at one stage below the current transmission gear position. If it is determined that there is a transmission gear position at one stage below the current transmission gear position (YES in S200), the process proceeds to S202. If not (NO in S200), the process proceeds to S204.

In S202, controller 60 determines whether the sum of first power Pa and second power Pb at the transmission gear position at one stage below the current transmission gear position is equal to or less than discharge power limit value Wout. If it is determined that the sum of first power Pa and second power pb at the transmission gear position at one stage below the current transmission gear position is equal to or less than discharge power limit value Wout (YES in S202), the process proceeds to S212. If not (NO in S202), the process proceeds to S204.

In S204, controller 60 determines whether there is a transmission gear position at one stage above the current transmission gear position. In some embodiments, for example, if the current transmission gear position is one of the first gear position to the third gear position, controller 60 determines that there is a transmission gear position at one stage above the current transmission gear position. If the current transmission gear position is the fourth gear position, controller 60 determines that there is no transmission gear position at one stage above the current transmission gear position. If it is determined that there is a transmission gear position at one stage above the current transmission gear position (YES in S204), the process proceeds to S206. If not (NO in S204), the process proceeds to S208.

In S206, controller 60 determines whether the sum of first power Pa and second power Pb at the transmission gear position at one stage above the current transmission gear position is equal to or less than discharge power limit value Wout. If it is determined that the sum of first power Pa and second power Pb at the transmission gear position at one stage above the current transmission gear position is equal to or less than discharge power limit value Wout (YES in S206), the process proceeds to S212. If not (NO in S206), the process proceeds to S208.

In S208, controller 60 determines whether there is a transmission gear position at two stages below the current transmission gear position. In some embodiments, for example, if the current transmission gear position is one of the third gear position and the fourth gear position, controller 60 determines that there is a transmission gear position at two stages below the current transmission gear position. If the current transmission gear position is one of the first gear position and the second gear position, controller 60 determines that there is no transmission gear position at two stages below the current transmission gear position. If it is determined that there is a transmission gear position at two stages below the current transmission gear position (YES in S208), the process proceeds to S210. If not (NO in S208), the process proceeds to S214.

In S210, controller 60 determines whether the sum of first power Pa and second power Pb at the transmission gear position at two stages below the current transmission gear position is equal to or less than discharge power limit value Wout. If it is determined that the sum of first power Pa and second power Pb at the transmission gear position at two stages below the current transmission gear position is equal to or less than discharge power limit value Wout (YES in S210), the process proceeds to S212. If not (NO in S210), the process proceeds to S214.

In S212, controller 60 determines a target transmission gear position. Specifically, if it is determined in S202 that the sum of first power Pa and second power Pb at the transmission gear position at one stage below the current transmission gear position is equal to or less than discharge power limit value Wout, controller 60 determines the transmission gear position at one stage below the current transmission gear position as a target transmission gear position. If it is determined in S206 that the sum of first power Pa and second power Pb at the transmission gear position at one stage above the current transmission gear position is equal to or less than discharge power limit value Wout, controller 60 determines the transmission gear position at one stage above the current transmission gear position as a target transmission gear position. If it is determined in S210 that the sum of first power Pa and second power Pb at the transmission gear position at two stages below the current transmission gear position is equal to or less than discharge power limit value Wout, controller 60 determines the transmission gear position at two stages below the current transmission gear position as a target transmission gear position.

In S214, controller 60 determines that the transmission gear position is maintained. Controller 60 then causes the process to proceed to S108.

In this case, for determining whether the sum of first power Pa and second power Pb is equal to or less than discharge power limit value Wout, this determination is made in the predetermined order in which priorities are given to adjoining transmission gear positions, for example, in order of the transmission gear position at one stage below, the transmission gear position at one stage above, and the transmission gear position at two stages below, and the like. Then, the transmission gear position, at which the sum of first power Pa and second power Pb is first determined as being equal to or less than discharge power limit value Wout, is determined as a target transmission gear position. Accordingly, the sum of first power Pa and second power Pb can be decreased while suppressing an increase in the number of gear shifting times. In the example shown in FIG. 11, an explanation has been given with regard to an example in which the target transmission gear position is determined in the predetermined order of the transmission gear position at one stage below, the transmission gear position at one stage above, and the transmission gear position at two stages below, but the order and the number of transmission gear positions are not particularly limited thereto.

An example of the method of determining a target transmission gear position may be a method of determining, as a target transmission gear position, the transmission gear position exhibiting the smallest first power Pa.

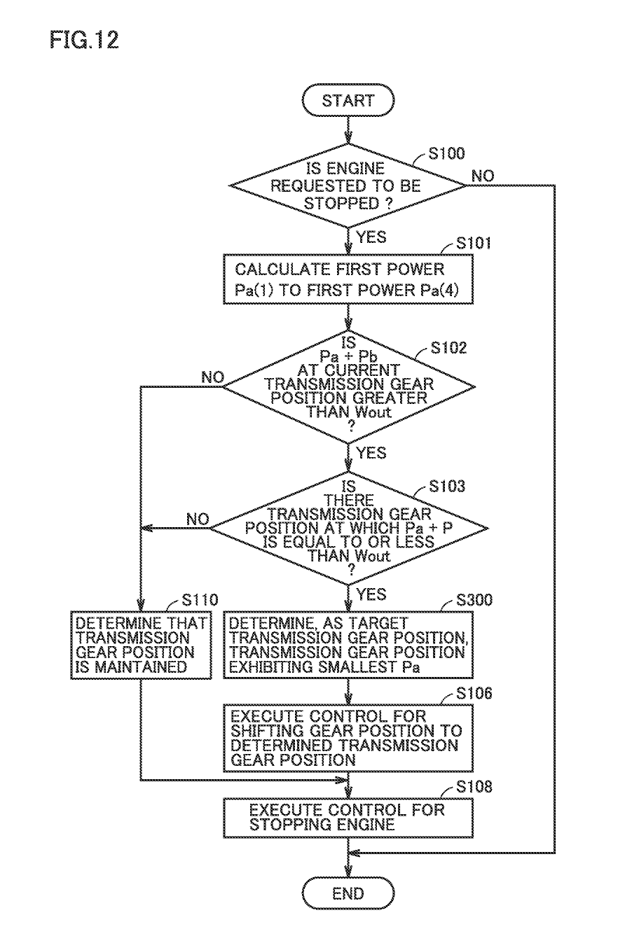

Specifically, controller 60 may execute the controlling process shown in FIG. 12. It is to be noted that the processes in S100 to S103, S106, S108, and S110 in the flowchart in FIG. 12 are the same as those in the processes in S100 to S103, S106, S108, and S110 in the flowchart in FIG. 8. Accordingly, detailed description thereof will not be repeated.

If it is determined in S103 that there is a transmission gear position at which the sum of first power Pa and second power Pb is equal to or less than Wout, controller 60 determines, in S300, the transmission gear position exhibiting the smallest first power Pa as a target transmission gear position.

In this way, since the transmission gear position exhibiting the smallest first power Pa is determined as a target transmission gear position, the sum of first power Pa and second power Pb can be decreased.

Furthermore, the method of determining a target transmission gear position may be a method of decreasing the sum of first power Pa and second power Pb at least at the current transmission gear position, or may be a method of determining, as a target transmission gear position, the transmission gear position that is adjacent to the current transmission gear position and that is smaller in sum of first power Pa and second power Pb than the current transmission gear position.

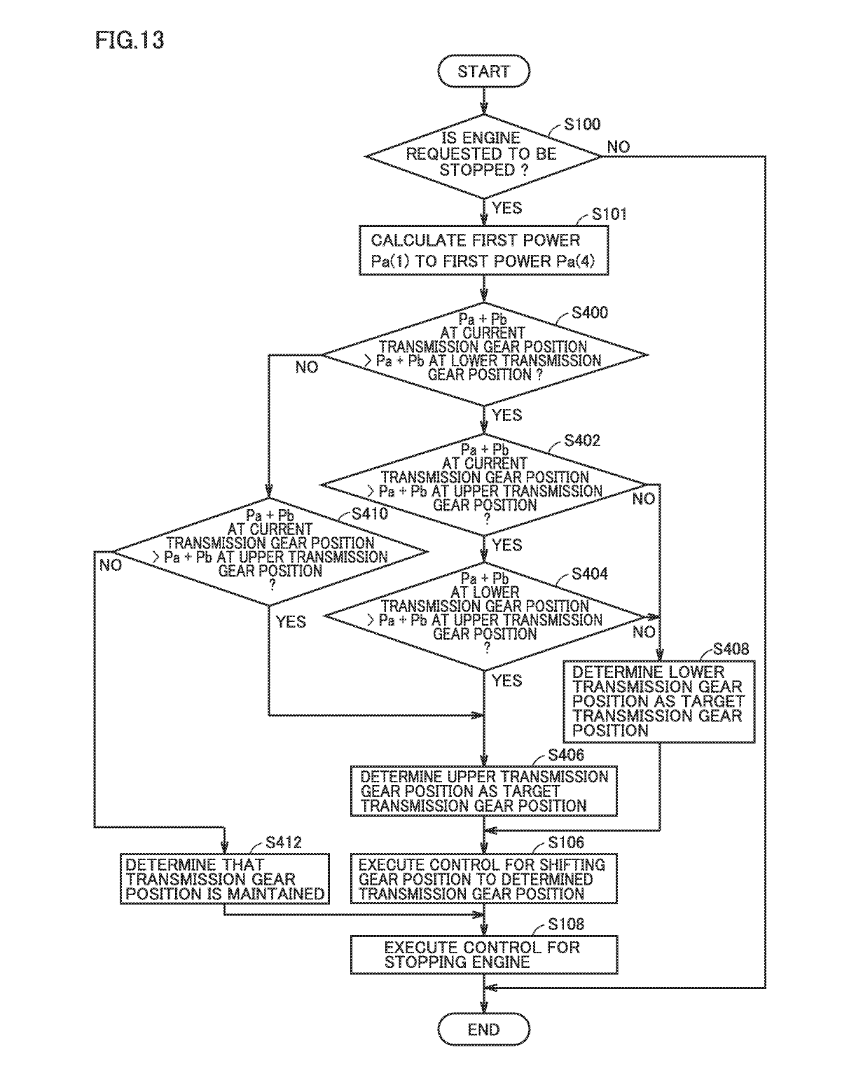

Specifically, controller 60 may execute the controlling process shown in FIG. 13. It is to be noted that the processes in S100, S101, S106, and S108 in FIG. 13 are the same as those in the processes in S100, S101, S106, and S108 in the flowchart in FIG. 8. Accordingly, detailed description thereof will not be repeated.

When first power Pa(1) to first power Pa(4) are calculated in S101, controller 60 determines in S400 whether the sum of first power Pa and second power Pb at the current transmission gear position is greater than the sum of first power Pa and second power Pb at the transmission gear position at one stage below the current transmission gear position (which will be hereinafter referred to as a lower transmission gear position). If it is determined that the sum of first power Pa and second power Pb at the current transmission gear position is greater than the sum of first power Pa and second power Pb at the lower transmission gear position (YES in S400), the process proceeds to S402. If not (NO in S400), the process proceeds to S410.

In S402, controller 60 determines whether the sum of first power Pa and second power Pb at the current transmission gear position is greater than the sum of first power Pa and second power Pb at the transmission gear position at one stage above the current transmission gear position (which will be hereinafter referred to as an upper transmission gear position). If it is determined that the sum of first power Pa and second power Pb at the current transmission gear position is greater than the sum of first power Pa and second power Pb at the upper transmission gear position (YES in S402), the process proceeds to S404. If not (NO in S402), the process proceeds to S408.

In S404, controller 60 determines whether the sum of first power Pa and second power Pb at the lower transmission gear position is greater than the sum of first power Pa and second power Pb at the upper transmission gear position. If it is determined that the sum of first power Pa and second power Pb at the lower transmission gear position is greater than the sum of first power Pa and second power Pb at the upper transmission gear position (YES in S404), the process proceeds to S406. If not (NO in S404), the process proceeds to S408.

In S406, controller 60 determines the upper transmission gear position as a target transmission gear position. In S408, controller 60 determines the lower transmission gear position as a target transmission gear position. In S410, controller 60 determines whether the sum of first power Pa and second power Pb at the current transmission gear position is greater than the sum of first power Pa and second power Pb at the upper transmission gear position. If it is determined that the sum of first power Pa and second power Pb at the current transmission gear position is greater than the sum of first power Pa and second power Pb at the upper transmission gear position (YES in S410), the process proceeds to S406. If not (NO in S410), the process proceeds to S412.

In S412, controller 60 determines that the transmission gear position is maintained. Controller 60 then causes the process to proceed to S108.

In this way, among the upper transmission gear position and the lower transmission gear position that are adjacent to the current transmission gear position, the transmission gear position exhibiting the smaller sum of first power Pa and second power Pb can be determined as a target transmission gear position. Accordingly, the sum of first power Pa and second power Pb can be decreased while suppressing an increase in the number of gear shifting times. In addition, the above-described method of determining a target transmission gear position may be changed as appropriate depending on the state of vehicle 10.

In the above-described embodiments, an explanation has been given with regard to the case where control for stopping engine 12 is executed after transmission gear shifting. However, after control for stopping engine 12 is completed, the shifted transmission gear position may be returned to the transmission gear position before shifting.

In the above-described embodiments, an explanation has been given with regard to the case where, when control for stopping engine 12 is executed, the operation of motor generator MG1 is controlled such that a prescribed torque in the negative rotation direction is generated in motor generator MG1. However, for example, the operation of motor generator MG1 may be controlled such that a larger torque is generated as the rotation speed of engine 12 is higher.

In the above-described embodiments, an explanation has been given with regard to the case where the rotation speed of engine 12 is reduced by the torque of motor generator MG1. However, for example, a reaction torque corresponding to the torque of motor generator MG1 may be generated in motor generator MG2. Thereby, the speed of vehicle 10 can be maintained. In this case, it is desirable for controller 60 that the sum of first power Pa, second power Pb, and reaction force power Pc in motor generator MG is equal to or less than discharge power limit value Wout of power storage device 54.

In the above-described embodiments, an explanation has been given with regard to the case where first power Pa(1) to first power Pa(4) corresponding to the first gear position to the fourth gear position, respectively, are calculated and the sum of first power Pa and second power Pb is compared with discharge power limit value Wout of power storage device 54 to determine a target transmission gear position. However, for example, the target transmission gear position may be determined based on rotation speeds Nm1 of motor generator MG1 after gear shifting, which correspond to the first to fourth gear positions. For example, the target transmission gear position to be determined may be a transmission gear position exhibiting the largest rotation speed Nm1 among rotation speeds Nm1 of motor generator MG1 after gear shifting, which correspond to the first to fourth gear positions. Alternatively, the target transmission gear position may be a transmission gear position at which rotation speed Nm1 is at least greater than zero. Thus, as rotation speed Nm1 of motor generator MG1 is larger in the positive rotation direction, a power generation operation is performed more when rotation speed Ne of engine 12 is reduced. Accordingly, the sum of first power Pa and second power Pb can be decreased by determining a target transmission gear position based on rotation speed Nm1 of motor generator MG1.

In the above-described embodiments, an explanation has been given with regard to the case where control for stopping engine 12 is executed after transmission gear shifting. However, for example, control for stopping engine 12 may be executed after transmission gear shifting, and during execution of stop control, the transmission gear position may be shifted to a transmission gear position at which first power Pa further decreases.

Although specific embodiments have been described above, it should be understood that the embodiments disclosed herein are illustrative and non-restrictive in every respect. The scope of the claimed subject matter is defined by the terms of the claims, and is intended to include any modifications within the meaning and scope equivalent to the terms of the claims.

What is claimed is:

1. A hybrid vehicle comprising:
an engine;
a first motor generator;
a second motor generator configured to output motive power to a driving wheel of the vehicle;
a transmission including a plurality of gear positions, and provided between the driving wheel and the second motor generator;
a differential including (i) a first rotating element connected to the first motor generator, (ii) a second rotating element connected to the second motor generator, and (iii) a third rotating element connected to an output shaft of the engine, the differential being configured such that, when rotation speeds of two rotating elements among the first rotating element, the second rotating element and the third rotating element are determined, a rotation speed of one remaining rotating element is determined;
a power storage device configured to transmit and receive electric power to and from each of the first motor generator and the second motor generator; and
a controller configured to, when rotation of the output shaft of the engine is stopped using the first motor generator during traveling of the vehicle, (i) shift a gear position so as to decrease a sum of first power required for operating the first motor generator and second power required for driving the driving wheel, and (ii) reduce a rotation speed of the engine using the first motor generator.

2. The hybrid vehicle according to claim 1, wherein
the controller is configured to shift the gear position so as to decrease the first power when rotation of the output shaft of the engine is stopped using the first motor generator during traveling of the vehicle and when the sum of the first power and the second power at a current gear position exceeds an upper limit value of discharge power of the power storage device.

3. The hybrid vehicle according to claim 1, wherein
the controller is configured to shift the gear position to a first gear position as a target gear position when rotation of the output shaft of the engine is stopped using the first motor generator during traveling of the vehicle and when the sum of the first power and the second power at the first gear position as a target gear position is equal to or less than an upper limit value of discharge power of the power storage device.

4. The hybrid vehicle according to claim 1, wherein
the controller is configured to, when rotation of the output shaft of the engine is stopped using the first motor generator during traveling of the vehicle, determine, as a target gear position, a gear position that is closest to a current gear position and at which the sum of the first power and the second power is equal to or less than an upper limit value of discharge power of the power storage device.

5. The hybrid vehicle according to claim 1, wherein
the controller is configured to, when rotation of the output shaft of the engine is stopped using the first motor generator during traveling of the vehicle, determine, as a target gear position, a gear position exhibiting the smallest first power among the plurality of gear positions.

6. The hybrid vehicle according to claim 1, wherein the controller is configured to determine, as a target gear position, a gear position that is adjacent to a current gear position and at which the sum of the first power and the second power is smaller than the sum of the first power and the second power at the current gear position.
